(19) United States
(12) Patent Application Publication
(10) Pub. No.: US 2024/0337891 A1
(43) Pub. Date: Oct. 10, 2024

(54) OPTICAL MEMBER

(71) Applicant: FUJIFILM Corporation, Tokyo (JP)

(72) Inventors: Yukito SAITOH, Kanagawa (JP); Hideki YASUDA, Kanagawa (JP); Yujiro YANAI, Kanagawa (JP)

(73) Assignee: FUJIFILM Corporation, Tokyo (JP)

(21) Appl. No.: 18/663,808

(22) Filed: May 14, 2024

Related U.S. Application Data
(63) Continuation of application No. PCT/JP2022/044241, filed on Nov. 30, 2022.

(30) Foreign Application Priority Data
Dec. 3, 2021 (JP) 2021-196992

(51) Int. Cl. G02F 1/29; G02B 1/00

(52) U.S. Cl. CPC G02F 1/292; G02B 1/002

(57) ABSTRACT

An optical member having a high reflectivity of electromagnetic waves in a desired direction for use in a metasurface structure. The optical member includes, in the following order: a reflective layer; a liquid crystal layer that includes a liquid crystal compound; and a metasurface structure where a plurality of microstructures are arranged, in which an in-plane refractive index of the liquid crystal layer continuously changes according to a region of the metasurface structure where two or more microstructures arranged adjacent to each other are present.

### CROSS-REFERENCE TO RELATED APPLICATIONS

This application is a Continuation of PCT International Application No. PCT/JP2022/044241 filed on Nov. 30, 2022, which was published under PCT Article 21(2) in Japanese, and which claims priority under 35 U.S.C. § 119(a) to Japanese Patent Application No. 2021-196992 filed on Dec. 3, 2021. The above applications are hereby expressly incorporated by reference, in their entirety, into the present application.

### BACKGROUND OF THE INVENTION

### 1. Field of the Invention

The present invention relates to an optical member including a metasurface structure.

### 2. Description of the Related Art

High-frequency radio waves (millimeter waves, terahertz waves) required for high-capacity wireless communication have high straightness. Therefore, for example, in order to deliver radio waves to the entire area in a room, a reflective plate that is attached to a wall or the like and bends radio waves in any direction is required.

However, a typical reflective plate exhibits specular reflection, and an incidence angle and an emission angle are the same. Therefore, for example, there is a problem in that it is difficult to deliver radio waves deep into the room or the like.

On the other hand, a device that bends electromagnetic waves in a direction different from specular reflection using a dynamic element such as liquid crystal is also disclosed.

For example, as conceptually shown in the upper section of FIG. 6, Jingbo Wu et al., Liquid crystal programmable metasurface for terahertz beam steering, Applied Physics Letters, 116, 131104 (2020) describes an electromagnetic reflecting device (beam steering device) where a liquid crystal layer 104 is interposed between a metasurface structure 100 and an electrode layer 102.

In the metasurface structure 100, resonators 100a as microstructures are arranged as in a well-known metasurface structure. In the reflecting device shown in FIG. 6, each of the resonators 100a configuring the metasurface structure 100 acts not only as a reflector but also as an electrode.

In addition, the electrode layer 102 also acts as a reflective layer of incident electromagnetic waves.

In the liquid crystal layer 104, for example, a rod-like liquid crystal compound 104a is aligned. Hereinafter, the rod-like liquid crystal compound 104a will be simply referred to as the liquid crystal compound 104a.

In this reflecting device, in a state where a voltage is not applied between the resonator 100a and the electrode layer 102, the liquid crystal compound 104a is aligned such that a longitudinal direction, that is, a direction of an optical axis matches with a thickness direction.

In a case where a voltage is applied between the resonator 100a and the electrode layer 102 in this state, The liquid crystal compound 104a is tilted in the thickness direction depending on the magnitude of the applied voltage.

In FIG. 6, for example, a high voltage is applied to the resonator 100a on the left side in the drawing, and a low voltage is applied to the resonator 100a on the right side in the drawing. As a result, the liquid crystal compound 104a positioned in a region of the resonator 100a on the left side in the drawing is largely tilted, and the longitudinal direction has an angle close to a main surface of the liquid crystal layer 104. On the other hand, the tilt of the liquid crystal compound 104a positioned in a region of the resonator 100a on the right side in the drawing is small, and the longitudinal direction has an angle close to the thickness direction of the liquid crystal layer 104.

The refractive index of the liquid crystal layer 104 increases as the tilt of the liquid crystal compound 104a increases, that is, as the angle of the longitudinal direction of the liquid crystal compound 104a becomes closer to the surface of the liquid crystal layer 104. Conversely, as the tilt of the liquid crystal layer 104a decreases, that is, as the angle of the longitudinal direction of the liquid crystal compound 104a becomes closer to the thickness direction of the liquid crystal layer 104, the refractive index of the liquid crystal layer 104 decreases.

Accordingly, in this state, regarding the refractive index of the liquid crystal layer 104, the region of the resonator 100a on the left side in the drawing where the tilt of the liquid crystal compound 104a is large is large, and the region of the resonator 100a on the right side in the drawing where the tilt of the liquid crystal compound 104a is small is small.

Therefore, in the region of the resonator 100a on the left side in the drawing where the refractive index is high, as conceptually shown in the lower section of FIG. 6, the phase of incident electromagnetic waves changes more largely as compared to the region of the resonator 100a on the right side in the drawing where the refractive index is low.

As a result, in the region of the resonator 100a on the left side in the drawing, apparently, the optical path of electromagnetic waves is longer than that in the region of the resonator 100a on the right side in the drawing.

Accordingly, in a case where electromagnetic waves are incident from the normal direction of the liquid crystal layer 104, even in electromagnetic waves that are simultaneously incident, the emission of electromagnetic waves incident into the region of the resonator 100a on the left side in the drawing having a long optical path length from the reflecting device is later than that of electromagnetic waves incident into the region of the resonator 100a on the right side in the drawing having a short optical path length.

As a result, electromagnetic waves incident from the normal direction into the reflecting device and reflected from the reflecting device are reflected to be tilted toward the left side such that wavefronts thereof are aligned instead of being specularly reflected in the normal direction.

### SUMMARY OF THE INVENTION

Here, as shown in FIG. 6, in the metasurface structure 100, the resonators 100a are arranged to be spaced from each other.

Accordingly, in the device where the resonators 100a are used as electrodes, as shown in the upper section of FIG. 6, even in a case where a voltage is applied to the resonators 100a, a voltage is not applied between the resonators 100a, and the liquid crystal compound 104a is not tilted. That is, even in a case where a voltage is applied to the resonators 100a, a state where the refractive index of the liquid crystal layer 104 is the lowest is maintained between the resonators 100a.

Accordingly, in the reflecting device, in a state where a voltage is applied, the alignment of the liquid crystal compound 104a is discontinuous in the region including the resonator 100a and in the region between the resonators 100a. That is, in the reflecting device, in a state where a voltage is applied, the refractive index of the liquid crystal layer 104 largely varies in the region including the resonator 100a and the region between the resonators 100a.

As a result, as conceptually shown in the lower section of FIG. 6, a change in the phase of electromagnetic waves is discontinuous in the region including the resonator 100a and the region between the resonators 100a, and electromagnetic waves cannot be reflected in a desired direction between the resonators 100a.

Therefore, in the reflecting device in the related art where the liquid crystal layer 104 is interposed between the electrode layer 102 and the metasurface structure 100, the reflectivity of electromagnetic waves in a desired direction is low.

An object of the present invention is to solve the above-described problem of the related art and to provide an optical member that reflects light using a metasurface structure, in which electromagnetic waves can be reflected in a desired direction with a high reflectivity.

In order to achieve the object, the present invention has the following configurations.

[1] An optical member comprising, in the following order:
a reflective layer;
a liquid crystal layer that includes a liquid crystal compound; and
a metasurface structure where a plurality of microstructures are arranged,
in which an in-plane refractive index of the liquid crystal layer continuously changes according to a region of the metasurface structure where two or more microstructures arranged adjacent to each other are present.

[2] The optical member according to [1],
in which all of the plurality of microstructures have the same structure.

[3] The optical member according to [1] or [2],
in which the plurality of microstructures are arranged at regular intervals.

[4] The optical member according to any one of [1] to [3],
in which in the liquid crystal layer, the liquid crystal compound is immobilized.

[5] The optical member according to any one of [1] to [4],
wherein in the liquid crystal layer, an angle between an optical axis of the liquid crystal compound and a main surface of the liquid crystal layer continuously changes.

[6] The optical member according to any one of [1] to [5],
in which a direction in which the in-plane refractive index continuously changes in the liquid crystal layer and
an arrangement direction of the microstructures in the metasurface structure match with each other.

[7] The optical member according to any one of [1] to [6],
in which in a case where a region of the liquid crystal layer where the in-plane refractive index changes from a maximum value to a minimum value is set as a single period, the liquid crystal layer repeatedly includes the single period in at least one direction.

[8] The optical member according to any one of [1] to [7],
in which a wavelength of target electromagnetic waves is 10 μm to 1 cm.

According to the present invention, provided is an optical member having a high reflectivity of electromagnetic waves in a desired direction for use in a metasurface structure.

### BRIEF DESCRIPTION OF THE DRAWINGS

FIG. 1 is a cross sectional view conceptually showing an example of an optical member according to the present invention.

FIG. 2 is a perspective view conceptually showing the optical member shown in FIG. 1.

FIG. 3 is a conceptual diagram showing an action of the optical member according to the present invention.

FIG. 4 is a conceptual diagram showing Example of the present invention.

FIG. 5 is a conceptual diagram showing Example of the present invention.

FIG. 6 is a cross sectional view showing an example of an optical member in the related art.

### DESCRIPTION OF THE PREFERRED EMBODIMENTS

Hereinafter, an optical member according to the present invention will be described in detail based on preferable embodiments shown in the accompanying drawings.

In the present specification, numerical ranges represented by “to” include numerical values before and after “to” as lower limit values and upper limit values.

In the present specification, the meaning of “the same” includes a case where an error range is generally allowable in the technical field.

Further, all the drawings described below are conceptual diagrams for describing the optical member according to the embodiment of the present invention. Accordingly, a shape, a size, a thickness, a positional relationship, and the like of each of members do not necessarily match with the actual ones.

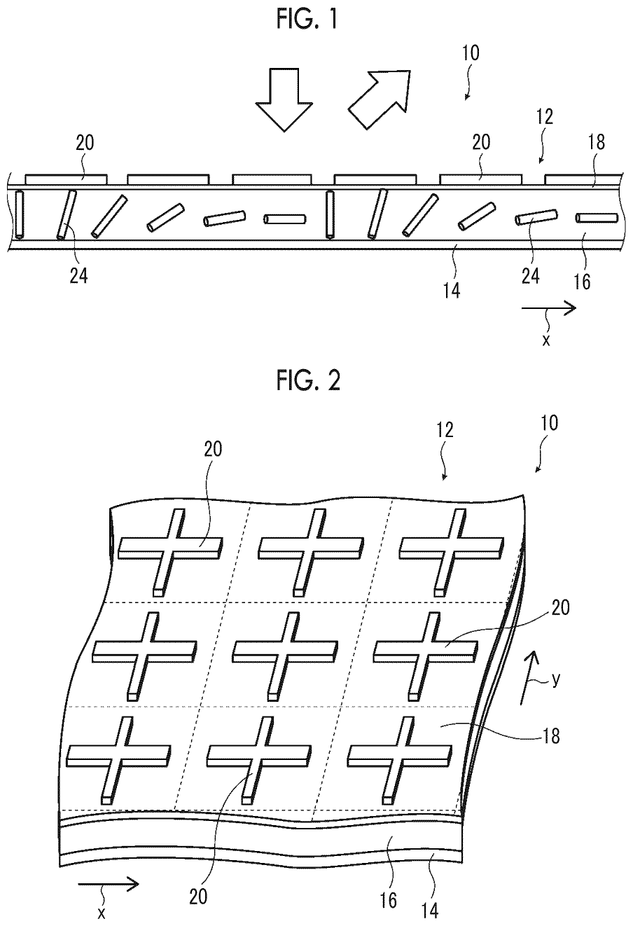

FIG. 1 conceptually shows an example of a cross section of the optical member according to the embodiment of the present invention. FIG. 2 conceptually shows a perspective view of the optical member shown in FIG. 1. In FIG. 1, in order to clearly show a configuration of the optical member, hatching is omitted.

An optical member 10 shown in FIG. 1 includes a metasurface structure 12, a reflective layer 14, and a liquid crystal layer 16, and has a configuration in which the liquid crystal layer 16 is interposed between the metasurface structure 12 and the reflective layer 14. That is, the optical member 10 includes the reflective layer 14, the liquid crystal layer 16, and the metasurface structure 12 in this order.

In the optical member 10, the reflective layer 14 and the liquid crystal layer 16 are bonded and the liquid crystal layer 16 and the metasurface structure 12 (substrate 18) are bonded optionally using a bonding agent (pressure sensitive adhesive, adhesive).

A bonding method is not limited, and various well-known methods capable of allowing target electromagnetic waves of the optical member 10 to be transmittable, for example, a method of using an optical clear adhesive (OCA) through which target electromagnetic waves of the optical member 10 are transmittable can be used.

In the metasurface structure 12, resonators 20 as microstructures are two-dimensionally arranged on the substrate 18.

In the metasurface structure 12 in the example shown in the drawing, the resonators 20 are two-dimensionally arranged at regular intervals in an x direction and a y direction orthogonal to each other.

In the metasurface structure 12, the phase of electromagnetic waves is modulated using the resonance of the resonators 20 by the arrangement of unit cells indicated by a broken line in FIG. 2 each of which consists of one resonator 20 and a space around the resonators 20.

In the metasurface structure 12 of the optical member 10, a cross-shaped three-dimensional structure where cuboids intersect with other is used as the resonator 20 as conceptually shown in FIG. 2. In the optical member 10 in the example shown in the drawing, all of the resonators 20 are the cross-shaped resonators.

In the liquid crystal layer 16, a liquid crystal compound 24 is aligned in a thickness direction and immobilized.

In the optical member 10 in the example shown in the drawing, the liquid crystal compound 24 of the liquid crystal layer 16 is, for example, a rod-like liquid crystal compound. Accordingly, an optical axis of the liquid crystal compound 24 matches with a longitudinal direction (major axis direction).

An in-plane refractive index of the liquid crystal layer 16 continuously changes according to a region of the metasurface structure 12 where two or more resonators 20 arranged adjacent to each other are present.

In the optical member 10 in the example shown in the drawing, the alignment direction of the liquid crystal compound 24 of the liquid crystal layer 16 in the thickness direction continuously changes in the x direction from a state where the liquid crystal compound 24 is aligned such that the longitudinal direction matches with the thickness direction of the liquid crystal layer 16 to a state where the liquid crystal compound 24 is aligned such that the longitudinal direction is parallel to a main surface of the liquid crystal layer 16. That is, in the liquid crystal compound 24, an angle between the longitudinal direction (optical axis) and the main surface (surface) of the liquid crystal layer 16 continuously changes in the x direction.

As a result, in the liquid crystal layer 16, the in-plane refractive index continuously changes in the x direction with respect to the arrangement of two or more resonators 20 adjacent to each other from a state where the in-plane refractive index is the lowest and the liquid crystal compound 24 is aligned such that the longitudinal direction matches with the thickness direction of the liquid crystal layer 16 to a state where the in-plane refractive index is the lowest and the liquid crystal compound 24 is aligned such that the longitudinal direction is parallel to the main surface of the liquid crystal layer 16.

In the following description, unless specified otherwise, “thickness direction” refers to the thickness direction of the liquid crystal layer 16, and “main surface” refers to the main surface of the liquid crystal layer 16.

In addition, in the following description, for convenience of description, the state where the liquid crystal compound 24 is aligned such that the longitudinal direction matches with the thickness direction will be referred to as vertical alignment, and the state where the liquid crystal compound 24 is aligned such that the longitudinal direction is parallel to the main surface will be referred to as horizontal alignment.

In the optical member 10 including the metasurface structure 12, the liquid crystal layer 16, and the reflective layer 14, reflected electromagnetic waves from the reflective layer 14 and the resonators 20 (unit cells) of the metasurface structure 12 are controlled by the phase modulation by the liquid crystal layer 16, and incident electromagnetic waves are reflected in a direction different from specular reflection.

For example, as conceptually shown in FIG. 1, in a case where electromagnetic waves are incident from the normal direction of the liquid crystal layer 16, the electromagnetic waves are reflected in a direction tilted with respect to the normal direction instead of the normal direction.

This point will be described in detail below.

In the present invention, the in-plane refractive index refers to an average value of a refractive index MX in a direction in which a maximum refractive index is exhibited in an in-plane direction and a refractive index MI in an in-plane direction orthogonal to the direction in which the refractive index MX is exhibited at a certain position in a plane of the liquid crystal layer 16. In addition, the refractive index refers to a refractive index at a wavelength of target electromagnetic waves of the optical member 10, that is, a refractive index at a wavelength of electromagnetic waves reflected from the optical member 10.

The main surface is the maximum surfaces of a sheet-shaped material (a plate-shaped material, a film, or a layer), and is typically both surfaces of the sheet-shaped material in the thickness direction.

In addition, the normal direction is a direction orthogonal to a surface such as the main surface of the sheet-shaped material, and is typically the thickness direction of the sheet-shaped material. In the optical member 10 in the example shown in the drawing, the normal direction matches with a laminating direction of the metasurface structure 12, the liquid crystal layer 16, and the reflective layer 14.

As described above, in the metasurface structure 12, the resonators 20 as microstructures are arranged on one surface of the substrate 18.

The substrate 18 is not limited, and various well-known sheet-shaped materials can be used as long as they can support the resonators 20 and allows transmission of target electromagnetic waves of the optical member 10. “The target electromagnetic waves of the optical member 10” are specifically electromagnetic waves to be reflected from the optical member 10.

Examples of the substrate 18 include a metal substrate including an oxide insulating layer such as a silicon substrate including silicon oxide, a substrate formed of an oxide such as silicon oxide, a semiconductor substrate such as a germanium substrate or a chalcogenide glass substrate, a resin film, for example, a polyacrylic resin film such as polymethyl methacrylate, a cellulose resin film such as cellulose triacetate, a cycloolefin polymer film, a polyethylene terephthalate (PET) film, a polycarbonate film, or a polyvinyl chloride resin film, and a glass plate. Examples of the cycloolefin polymer film include trade name “ARTON”, manufactured by JSR Corporation and trade name “ZEONOR”, manufactured by Zeon Corporation).

The thickness of the substrate 18 is not limited, and may be appropriately set depending on a forming material of the substrate 18 such that the resonators 20 can be supported, sufficient transmittance with respect to the target electromagnetic waves of the optical member 10 can be obtained, and a sufficient strength can be obtained depending on the use of the optical member 10 and the like.

In the optical member 10 according to the embodiment of the present invention, the metasurface structure 12 is not limited to including the substrate 18.

That is, in the optical member according to the embodiment of the present invention, if possible, the resonators 20 may be directly arranged on the surface of the liquid crystal layer 16 to form the metasurface structure 12.

The resonators 20 are arranged on one surface of the substrate 18. As a result, the metasurface structure 12 is formed.

As described above, in the metasurface structure 12, the resonators 20 as microstructures are two-dimensionally arranged to be spaced from each other on a plane. Basically, the metasurface structure 12 is configured by the arrangement of the unit cells each of which is formed by one resonator 20 and a space around the resonator 20.

In the optical member according to the embodiment of the present invention, the metasurface structure is basically a well-known metasurface structure (metamaterial). Accordingly, in the optical member 10 according to the embodiment of the present invention, various well-known metasurface structures can be used.

That is, in the present invention, the shape and forming material of the resonators 20, the arrangement of the resonators 20, the interval (pitch) of the resonators 20, and the like are not limited.

In addition, the metasurface structure 12 may be designed using a well-known method depending on reflection characteristics of the target electromagnetic waves of the optical member 10 according to the embodiment of the present invention. For example, the amplitude and the phase of electromagnetic waves reflected from the resonators 20 may be calculated using commercially available simulation software, and the arrangement of the resonators 20 may be set to obtain a desired distribution of phase modulation amount (refractive index).

In the example shown in the drawing, as a preferable example, the resonators 20 that have all the same structure are two-dimensionally arranged at regular intervals in the x direction and the y direction orthogonal to each other.

As described above, all the resonators 20 are cross-shaped three-dimensional structures where cuboids intersect with each other at the center.

Basically, the metasurface structure 12 is configured by the arrangement of the unit cells each of which is formed by one resonator 20 and a space around the resonator 20. The metasurface structure 12 modulates the phase of incident electromagnetic waves using the resonance of the resonators 20 by the arrangement of the unit cells.

In the optical member 10 according to the embodiment of the present invention, basically, one unit cell includes one resonator 20. However, the present invention is not limited to this configuration. That is, in the optical member according to the embodiment of the present invention, optionally, one unit cell may include a plurality of resonators 20 depending on desired optical characteristics, the size, forming material, and shape of the resonators 20, the size of the unit cells, and the like. In this case, one unit cell may include different resonators 20. Note that, in a case where one unit cell includes a plurality of resonators 20, basically, the phase modulation amounts in the spaces of the unit cells where the resonators are present are the same.

In the optical member 10 according to the embodiment of the present invention, the forming material of the resonators 20 configuring the metasurface structure 12 is not limited, and various materials that can be used as a resonators in well-known metasurface structures can be used.

Examples of the forming material of the resonators 20 include a metal and a dielectric. In the case of the metal, copper, gold, or silver is preferable from the viewpoint that, for example, optical loss is small. On the other hand, in the case of the dielectric, silicon, titanium oxide, or germanium is preferable from the viewpoint that, for example, the refractive index is high and large phase modulation can be performed.

Likewise, the shape of the resonators 20 configuring the metasurface structure 12 is not also limited, and various shapes that can be used as resonators in well-known metasurface structures can be used.

For example, the above-described cross-shaped three-dimensional structure where cuboids intersect with each other, a cuboid shape, a cylindrical shape, a V-shaped three-dimensional structure where cuboids are connected to end parts as described in JP2018-046395A, a H-shaped three-dimensional structure such as H-steel, or a substantially C-shaped three-dimensional structure such as a C-channel can be used.

In addition, as the V-shaped three-dimensional structure or the cross-shaped three-dimensional structure shown in JP2018-046395A, various shapes where an angle between two cuboids is adjusted can be used.

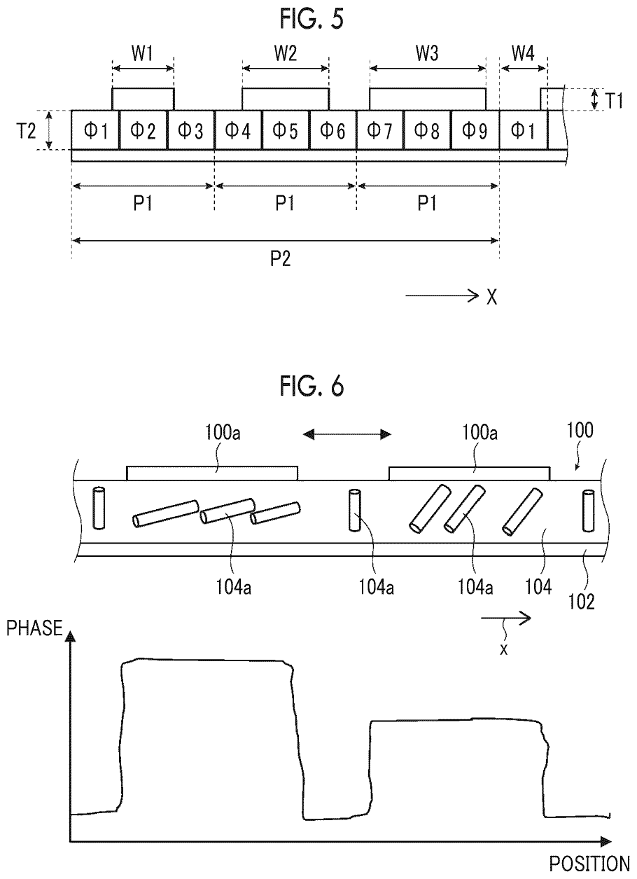

In addition, a three-dimensional structure having a bottom surface shape shown in FIG. 5 of “Appl. Sci. 2018, 8(9), 1689; https://doi.org/10.3390/app8091689” can also be used.

In the metasurface structure 12, as the resonator 20, only one resonator may be used, or plural kinds of resonator may be used in combination. In addition, the same resonators 20 may be arranged in the same orientation as shown in FIG. 2 or in different orientations, or the resonators 20 arranged in the same orientation and the resonators 20 arranged in different orientations may be mixed.

However, in the optical member according to the embodiment of the present invention, it is preferable that only one kind of the resonators 20 are used and all the resonators 20 are arranged in the same orientation.

The reflective layer 14 reflects incident electromagnetic waves together with the resonators 20 (unit cells) of the metasurface structure 12.

In the optical member 10, as described above, reflected electromagnetic waves from the reflective layer 14 and reflected electromagnetic waves from the resonators 20 of the metasurface structure 12 interfere with each other such that the incident electromagnetic waves are reflected.

The reflective layer 14 is not limited, and various well-known sheet-shaped materials can be used as long as they can reflect target electromagnetic waves of the optical member 10.

For example, in a case where the target electromagnetic waves of the optical member 10 are electromagnetic waves having a wavelength of 10 μm to 1 cm, examples of the reflective layer 14 include a metal layer such as copper, aluminum, gold, or silver, an inorganic conductive material such as tin-doped indium oxide (ITO), an organic conductive material such as polythiophene, and graphene.

In addition, the reflective layer 14 of the optical member 10 does not need to be a layer (solid layer) that is uniform over the entire surface, and may have a structure having a uniform reflectivity distribution in a plane as in the uniform layer. For example, the reflective layer 14 may have a metal mesh structure.

The thickness of the reflective layer 14 is not limited, and may be appropriately set depending on the forming material of the reflective layer 14 such that target electromagnetic waves can be reflected with a necessary reflectivity.

In the optical member 10 according to the embodiment of the present invention, the liquid crystal layer 16 is provided between the metasurface structure 12 and the reflective layer 14.

As described above, in the liquid crystal layer 16, the liquid crystal compound 24 is aligned and immobilized. In the optical member 10 in the example shown in the drawing, the liquid crystal compound 24 of the liquid crystal layer 16 is, for example, a rod-like liquid crystal compound.

In the optical member 10 according to the embodiment of the present invention, an in-plane refractive index of the liquid crystal layer 16 continuously changes according to a region of the metasurface structure 12 where two or more resonators 20 arranged adjacent to each other are present.

In the optical member 10 in the example shown in the drawing, the alignment direction of the liquid crystal compound 24 of the liquid crystal layer 16 in the thickness direction continuously changes in the x direction from the vertical alignment where the liquid crystal compound 24 is aligned such that the longitudinal direction matches with the thickness direction to the horizontal alignment where the liquid crystal compound 24 is aligned such that the longitudinal direction is parallel to the main surface.

That is, in the liquid crystal compound 24, an angle between the longitudinal direction (optical axis) and the main surface (surface) of the liquid crystal layer 16 continuously changes in the x direction.

In the liquid crystal layer 16, the in-plane refractive index is the lowest in the state where the liquid crystal compound 24 is vertically aligned. In the In the liquid crystal layer 16, the in-plane refractive index is the lowest in the state where the liquid crystal compound 24 is horizontally aligned.

That is, in the liquid crystal layer 16, as the angle between the longitudinal direction of the liquid crystal compound 24 and the main surface decreases, the in-plane refractive index increases, and as the angle between the optical axis of the liquid crystal compound 24 and the main surface becomes closer to 90°, the in-plane refractive index decreases.

Accordingly, in the liquid crystal layer 16, the in-plane refractive index continuously changes in the x direction that is the arrangement direction of the resonators 20 in the metasurface structure 12 from a state where the in-plane refractive index is the lowest and the liquid crystal compound 24 is vertically aligned to a state where the in-plane refractive index is the highest and the liquid crystal compound 24 is horizontally aligned.

In addition, in the liquid crystal layer 16, a region where the in-plane refractive index changes from a maximum value to a minimum value is set as a single period. That is, in the example shown in the drawing, in the liquid crystal layer 16, the single period is a region from a position where the liquid crystal compound 24 is vertically aligned to a position where the liquid crystal compound 24 is horizontally aligned. FIG. 1 shows two periods.

In the optical member 10 shown in FIG. 1, the liquid crystal compound 24 is aligned such that the liquid crystal layer 16 corresponding to three continuous resonators 20 in the x direction forms the single period. In the example shown in the drawing, in the liquid crystal layer 16, the single period where the in-plane refractive index changes from the minimum value to the maximum value is repeated per three continuous resonators 20 in the x direction. That is, in the liquid crystal layer 16, the single period is repeated in the x direction.

In the optical member 10 according to the embodiment of the present invention, the liquid crystal layer 16 may be manufactured using a well-known method depending on an alignment pattern of the liquid crystal compound 24 in the thickness direction in the liquid crystal layer 16.

Accordingly, the liquid crystal compound for forming the liquid crystal layer 16 is not limited, and may be a rod-like liquid crystal compound as shown in FIG. 1 or may be a disk-like liquid crystal compound.

### —Rod-Like Liquid Crystal Compound—

As the rod-like liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used.

As the rod-like liquid crystal compound, not only the above-described low molecular weight liquid crystal molecules but also polymer liquid crystal molecules can be used.

In the liquid crystal layer 16, it is preferable that the alignment of the rod-like liquid crystal compound is immobilized by polymerization. That is, it is preferable that the liquid crystal layer 16 is a layer obtained by polymerizing and immobilizing a polymerizable rod-like liquid crystal compound.

Examples of the polymerizable rod-like liquid crystal compound include compounds described in Makromol. Chem., (1989), Vol. 190, p. 2255, Advanced Materials (1993), Vol. 5, p. 107, Advanced Photonics Vol. 2, Art. 036002 (2020), U.S. Pat. Nos. 4,683,327A, 5,622,648A, 5,770,107A, WO95/022586A, WO95/024455A, WO97/000600A, WO98/023580A, WO98/052905A, JP1989-272551A (JP-H1-272551A), JP1994-016616A (JP-H6-016616A), JP1995-110469A (JP-H7-110469A), JP1999-080081A (JP-H11-080081A), and JP2001-064627A.

Further, as the rod-like liquid crystal compound, for example, compounds described in JP1999-513019A (JP-H11-513019A) and JP2007-279688A can also be preferably used.

### —Disk-Like Liquid Crystal Compound—

As the disk-like liquid crystal compound, for example, compounds described in JP2007-108732A and JP2010-244038A can be preferably used.

The liquid crystal layer 16 where the liquid crystal compound is aligned in the thickness direction as described above can be formed by applying a composition including a liquid crystal compound to an alignment film having a desired alignment pattern, drying the applied composition, and optionally polymerizing the liquid crystal compound as in a well-known liquid crystal layer where a liquid crystal compound is aligned in a thickness direction.

In the optical member 10 according to the embodiment of the present invention, an alignment film for aligning the liquid crystal compound 24 may be provided between the liquid crystal layer 16 and the reflective layer 14. That is, the alignment film may be provided on the surface of the reflective layer 14 to form the liquid crystal layer 16. Alternatively, a sheet-shaped material where an alignment film is formed on a support may be used, the liquid crystal layer 16 may be formed on the alignment film of the sheet-shaped material, and subsequently the liquid crystal layer 16 may be peeled off to transfer the alignment film to the reflective layer 14.

### —Alignment Film—

In the optical member 10 according to the embodiment of the present invention, as the alignment film for forming the alignment of the liquid crystal compound 24 configuring the liquid crystal layer 16 in the thickness direction, various well-known films can be used.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as ω-tricosanoic acid, dioctadecylmethylammonium chloride, or methyl stearate.

The alignment film formed by a rubbing treatment can be formed by rubbing a surface of a polymer layer with paper or fabric in a given direction multiple times.

As the material used for the alignment film, for example, a material for forming polyimide, polyvinyl alcohol, a polymer having a polymerizable group described in JP1997-152509A (JP-H9-152509A), or an alignment film such as JP2005-97377A, JP2005-99228A, and JP2005-128503A is preferable.

In the optical member according to the embodiment of the present invention, for example, the alignment film can be suitably used as a so-called photo-alignment film obtained by irradiating a photo-alignment material with polarized light or non-polarized light. That is, in the optical member according to the embodiment of the present invention, a photo-alignment film that is formed by applying a photo-alignment material to the support is suitably used as the alignment film.

Preferable examples of the photo-alignment material used in the photo-alignment film that can be used in the present invention include: an azo compound described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignment unit described in JP2002-265541A and JP2002-317013A; a photocrosslinking silane derivative described in JP4205195B and JP4205198B, a photocrosslinking polyimide, a photocrosslinking polyamide, or a photocrosslinking ester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-012823A.

Among these, an azo compound, a photocrosslinking polyimide, a photocrosslinking polyamide, a photocrosslinking ester, a cinnamate compound, or a chalcone compound is suitably used.

The thickness of the alignment film is not particularly limited. The thickness with which a required alignment function can be obtained may be appropriately set depending on the forming material of the alignment film.

The thickness of the alignment film is preferably 0.01 to 5 μm and more preferably 0.05 to 2 μm.

A method of forming the alignment film is not limited. Any one of various well-known methods corresponding to a forming material of the alignment film can be used.

For example, in a case where an alignment film formed of a photo-alignment material is used, a method of applying a composition including a material for forming an alignment film to a surface of a support, drying the applied composition, and exposing the alignment film to, for example, ultraviolet light to form an alignment pattern can be used.

In this case, for example, a film formed of a composition including a material for forming an alignment film is irradiated with linearly polarized light to form a photo-alignment film having a pretilt angle and/or an alignment restriction force that varies in a horizontal direction (direction parallel to the main surface). Next, using a mask of gray scales where the concentration changes continuously or stepwise, the alignment film is irradiated with unpolarized light from the normal direction through the gray scales.

As a result, an alignment film for forming the liquid crystal layer 16 where the angle between the longitudinal direction (optical axis) of the liquid crystal compound 24 and the main surface continuously changes can be formed can be obtained.

In the optical member 10 according to the embodiment of the present invention, the thickness of the liquid crystal layer 16 is not limited, and may be appropriately set depending on the forming material of the liquid crystal layer 16, the desired refractive index, that is, the desired phase modulation amount, and the like.

The thickness of the liquid crystal layer 16 is preferably 1 to 10000 μm, more preferably 10 to 5000 μm, and still more preferably 100 to 2000 μm.

In the optical member 10 according to the embodiment of the present invention, reflected electromagnetic waves from the reflective layer 14 and the resonators 20 (unit cells) of the metasurface structure 12 are controlled by the phase modulation by the liquid crystal layer 16, and incident electromagnetic waves are reflected in a direction different from specular reflection.

For example, as conceptually shown in FIG. 1, in a case where electromagnetic waves are incident from the normal direction of the liquid crystal layer 16, the electromagnetic waves are reflected in a direction tilted with respect to the normal direction instead of the normal direction.

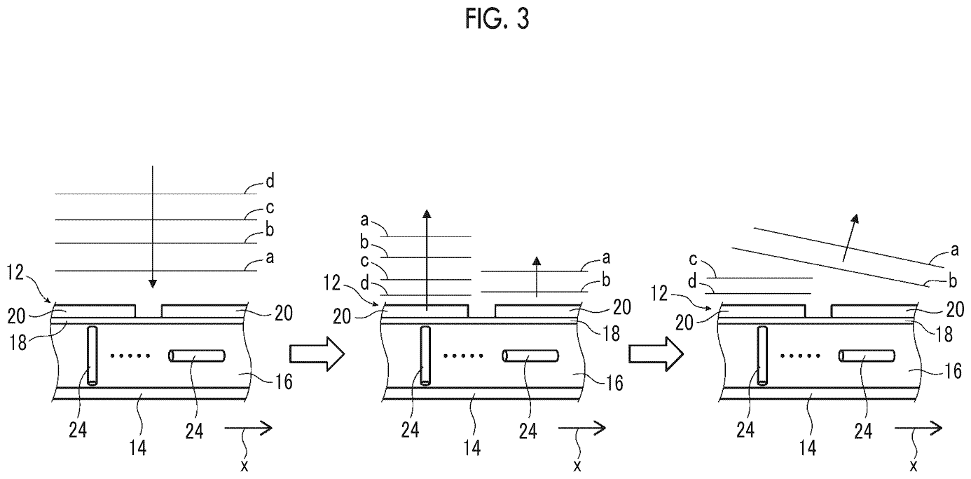

Hereinafter, the action of reflection different from specular reflection will be described with reference to the conceptual diagram of FIG. 3.

As shown on the left side of FIG. 3, in a case where electromagnetic waves are incident into the optical member 10 from the normal direction, the electromagnetic waves are incident into the optical member 10 in order of a wavefront a, a wavefront b, a wavefront c, a wavefront d, . . .

That is, the phases of the electromagnetic waves incident into the optical member 10 are aligned.

The phase modulation amounts by the resonators 20 (unit cells) of the metasurface structure 12, that is, the refractive indices of the resonators 20 are uniform over the entire surface of the optical member 10 in the in-plane direction.

Accordingly, after passing the metasurface structure 12, the phases of the electromagnetic waves incident into the optical member 10 are aligned.

On the other hand, in the liquid crystal layer 16, the alignment direction of the liquid crystal compound 24 continuously changes in the x direction from the state where the in-plane refractive index is the lowest and the liquid crystal compound 24 is vertically aligned to the state where the in-plane refractive index is the highest and the liquid crystal compound 24 is horizontally aligned. In addition, in the liquid crystal layer 16, the single period where the refractive index continuously changes from the maximum value to the minimum value is repeated in the direction of the change of the refractive index, that is, in the x direction.

The phase modulation amount of the electromagnetic waves incident into the liquid crystal layer 16 is large in a region where the refractive index is high.

Due to this configuration, in a region where the refractive index, that is, the phase modulation amount is large and the liquid crystal compound 24 is horizontally aligned, apparently, the optical path length of electromagnetic waves is longer than that in a region where the refractive index, that is, the phase modulation amount is small and the liquid crystal compound 24 is vertically aligned.

That is, in the single period of the liquid crystal layer 16, the apparent optical path length of electromagnetic waves continuously increases from the position where the liquid crystal compound 24 is vertically aligned toward the position where the liquid crystal compound 24 is horizontally aligned.

Therefore, even in a case where electromagnetic waves are simultaneously incident into the optical member 10, in the electromagnetic waves reflected from the reflective layer 14, the emission of electromagnetic waves incident into the position where the optical path length is short and the liquid crystal compound 24 is vertically aligned as shown at the center of FIG. 3 from the optical member 10 is the earliest. On the other hand, the emission of electromagnetic waves incident into the position where the optical path length is long and the liquid crystal compound 24 is horizontally aligned from the optical member 10 is the latest.

As a result, as shown on the right side of FIG. 3, the electromagnetic waves reflected and emitted from the optical member 10 are reflected in a direction tilted with respect to the normal direction instead of the normal direction in a state where the wavefronts of the electromagnetic waves emitted early and the electromagnetic waves emitted late are aligned.

Specifically, radio waves incident into the optical member 10 from the normal direction as in the example shown in the drawing are tilted in a direction in which the in-plane refractive index continuously increases in the liquid crystal layer 16, and are reflected in a direction tilted with respect to the normal direction.

Even in the device described in Jingbo Wu et al., Liquid crystal programmable metasurface for terahertz beam steering, Applied Physics Letters, 116, 131104 (2020) where the liquid crystal layer 104 is interposed between the metasurface structure 100 and electrode layer 102 and the resonators 100a are used as electrodes, by applying a voltage between the electrode layer 102 and the resonators 100a such that the alignment direction of the liquid crystal compound 104a changes in the thickness direction, incidence light can be reflected in a direction different from specular reflection.

However, as described above, in this device, a voltage is not applied between the resonators 100a. Therefore, at this position, the alignment direction of the liquid crystal compound 104a does not change. As a result, in this device, the refractive index of the liquid crystal layer 104, that is, the phase modulation amount of the electromagnetic waves largely varies in the position including the resonator 100a and the position between the resonators 100a.

Therefore, in the device, in the region between the resonators 100a, electromagnetic waves cannot be reflected in a predetermined direction, and the reflectivity of electromagnetic waves in the predetermined direction decreases.

On the other hand, in the optical member 10 according to the embodiment of the present invention, in the liquid crystal layer 16, for example, in the region where three resonators 20 adjacent to each other are present as shown in FIG. 1, the alignment direction of the liquid crystal compound 24 continuously changes in the x direction from the vertical alignment state where the single period, that is, the longitudinal direction matches with the thickness direction to the horizontal alignment state where the longitudinal direction is parallel to the main surface. It is preferable that the liquid crystal compound 24 is immobilized in the liquid crystal layer 16.

In the optical member 10, as described above, in the region where three resonators 20 adjacent to each other are present, the refractive index of the liquid crystal layer 16 continuously increases in the x direction. In other words, in the optical member 10, the refractive index of the liquid crystal layer 16 continuously changes in the arrangement direction of the three unit cells adjacent to each other. Accordingly, in the optical member 10 according to the embodiment of the present invention, in the region between the resonators 20 adjacent to each other, the refractive index of the liquid crystal layer 16 continuously changes in a direction from the resonator 20 toward the resonator 20.

Therefore, in the optical member 10 according to the embodiment of the present invention, a difference in the refractive index of the liquid crystal layer 16 is small in the position where the resonator 20 is present and in the position between the resonators 20. That is, in the optical member 10 according to the embodiment of the present invention, a difference in the phase modulation amount of electromagnetic waves by the liquid crystal layer 16 is small in the position where the resonator 20 is present and in the position between the resonators 20.

As a result, in the present invention, electromagnetic waves can be reflected in a predetermined direction even in the region between the resonators 20. As a result, in the optical member 10 according to the embodiment of the present invention, the reflectivity of electromagnetic waves in the predetermined direction can be increased.

In addition, by combining the metasurface structure 12 with the reflective layer 14 and the liquid crystal layer 16, even in the thin liquid crystal layer 16, the phase of incident electromagnetic waves can be sufficiently modulated, and a change in the reflection direction of electromagnetic waves with respect to specular reflection can be increased.

In the liquid crystal layer 16 of the optical member 10 in the example shown in the drawing, by continuously changing the alignment direction of the liquid crystal compound 24 in the thickness direction, the in-plane refractive index of the liquid crystal layer 16 can be continuously changed in the arrangement direction of the resonators 20.

However, in the present invention, a method of continuously changing the in-plane refractive index of the liquid crystal layer 16 according to the region where two or more resonators 20 arranged adjacent to each other are present is not limited, and various methods can be used.

For example, the refractive index of the liquid crystal compound 24 changes depending on the temperature during the formation of the liquid crystal layer 16. In general, as the temperature increases, the refractive index anisotropy of the liquid crystal compound 24 decreases.

Using this configuration, during the formation of the liquid crystal layer 16, the heating temperature of the liquid crystal layer 16 is patterned according to a desired pattern of the in-plane refractive index of the liquid crystal layer 16. As a result, for example, by setting the alignment direction of the liquid crystal layer 16 to the horizontal direction, as the temperature increases, the average in-plane refractive index decreases. This way, by continuously changing the refractive index of the liquid crystal layer 16, the liquid crystal layer where the in-plane refractive index continuously changes according to the region where two or more resonators 20 arranged adjacent to each other are present can be obtained.

In addition, a method of preparing plural kinds of compositions including liquid crystal compounds having different refractive indices, patterning each of the compositions according to a desired pattern of the in-plane refractive index of the liquid crystal layer 16, and applying the patterned compositions to form the liquid crystal layer where the in-plane refractive index continuously changes according to the region where two or more resonators 20 arranged adjacent to each other are present can also be used.

In the optical member 10 shown in FIG. 1, the single period of the liquid crystal layer 16 corresponds to three continuous resonators 20 in the x direction.

However, in the optical member according to the embodiment of the present invention, the number of the resonators 20 of the metasurface structure 12 corresponding to the single period of the liquid crystal layer 16 is not limited to three in the example shown in the drawing. That is, the number of the resonators 20 of the metasurface structure 12 corresponding to the single period of the liquid crystal layer 16 may be two or may be four or more.

As the length of the single period in the liquid crystal layer 16 decreases, an angle at which electromagnetic waves are reflected from the optical member 10 with respect to specular reflection largely changes. For example, in a case where electromagnetic waves are incident from the normal direction of the liquid crystal layer 16, as the length of the single period in the liquid crystal layer 16 decreases, the angle between the reflection direction of electromagnetic waves and the normal direction of the liquid crystal layer 16 increases.

In other words, in a case where the resonators 20 are arranged at regular intervals, as the number of the resonators 20 of the metasurface structure 12 corresponding to the single period of the liquid crystal layer 16 decreases, the angle between the reflection direction of electromagnetic waves and the normal direction of the liquid crystal layer 16 during incidence of electromagnetic waves from the normal direction of the liquid crystal layer 16 increases.

Accordingly, the number of the resonators 20 of the metasurface structure 12 corresponding to the single period of the liquid crystal layer 16 may be appropriately set according to the reflection direction of target electromagnetic waves of the optical member.

Assuming that the number of the resonators 20 of the metasurface structure 12 corresponding to the single period of the liquid crystal layer 16 is fixed, even in a case where the configuration of the metasurface structure 12 such as the shape of the resonators 20, the arrangement of the resonators 20, and the interval of the resonators 20 changes, the phase modulation characteristics (refractive index) of the metasurface structure 12 changes. Therefore, the reflection characteristics of electromagnetic waves by the optical member 10 change.

In the optical member 10 in the example shown in the drawing, the number of the resonators 20 of the metasurface structure 12 corresponding to the single period of the liquid crystal layer 16 is fixed at three. However, the present invention is not limited to this configuration.

That is, the optical member according to the embodiment of the present invention may include regions that are different in the number of the resonators 20 of metasurface structure 12 corresponding to the single period of the liquid crystal layer 16. That is, regarding the number of the resonators 20 of metasurface structure 12 corresponding to the single period of the liquid crystal layer 16, the optical member according to the embodiment of the present invention may include a region where the number is three, a region where the number is four, and a region where the number is five.

As described above, as the number of the resonators corresponding to the single period of the liquid crystal layer 16 decreases, for example, the angle of the reflection direction of electromagnetic waves incident from the normal direction increases with respect to the normal direction. Therefore, with the above-described configuration, an optical member that reflect incident electromagnetic waves to be collected or diffused depending on the direction of the change of the refractive index in the liquid crystal layer 16 can be manufactured.

In the optical member 10 in the example shown in the drawing, in the single period, the alignment direction of the liquid crystal compound 24 in the liquid crystal layer 16 changes from the vertical alignment where the longitudinal direction matches with the thickness direction to the horizontal alignment state where the longitudinal direction is parallel to the main surface. That is, the amount of change of the refractive index in the single period of the liquid crystal layer 16 is in a range from the minimum value to the maximum value that can be adopted with the change of the alignment direction of the liquid crystal compound 24 in the thickness direction.

However, the present invention is not limited to this configuration. That is, the amount of change of the refractive index in the single period of the liquid crystal layer 16 and the refractive index may be appropriately set depending on desired reflection characteristics of the optical member.

For example, the alignment direction of the liquid crystal compound 24 in the thickness direction in the single period of the liquid crystal layer 16 may change from a direction in which the longitudinal direction forms 45° with respect to the main surface to the horizontal alignment, or may change from the vertical alignment to the direction in which the longitudinal direction forms 45° with respect to the main surface.

As can be seen from the above description, by selecting the angle range of the change of the alignment direction of the liquid crystal compound 24 in the thickness direction in the single period, the range of the in-plane refractive index in the liquid crystal layer 16 can be adjusted. In addition, by selecting the angle of the alignment direction of the liquid crystal compound 24 in the thickness direction in the single period, the size of the in-plane refractive index in the liquid crystal layer 16 can be adjusted.

Accordingly, the range of the angle change of the alignment direction of the liquid crystal compound in the thickness direction in the single period of the liquid crystal layer 16 and the angle of the alignment direction of the liquid crystal compound in the thickness direction in the single period of the liquid crystal layer 16 may be appropriately set depending on the reflection direction of target electromagnetic waves of the optical member 10.

The optical member 10 in the example shown in the drawing is an optical member that reflects incident electromagnetic waves to tilt the electromagnetic waves in a predetermined one direction (x direction).

Therefore, in the metasurface structure 12 of the optical member 10, the resonators 20 that are all the same are used, and the resonators 20 are two-dimensionally arranged at regular intervals in the x direction and the y direction orthogonal to each other. In addition, in the liquid crystal layer 16, the single period is repeated in the x direction such that the change of the continuous change of the refractive index matches with the x direction of the arrangement direction of the resonators 20 and the refractive index continuously increases in the x direction.

However, as described above, the optical member according to the embodiment of the present invention is not limited to this configuration, and various configurations can be used.

For example, in the optical member 10 shown in FIG. 1, the refractive index in the single period of the liquid crystal layer 16 continuously increases to match with the x direction of the arrangement direction of the resonators 20. In the optical member according to the embodiment of the present invention, conversely, the refractive index in the single period of the liquid crystal layer 16 may continuously decrease to match with the x direction of the arrangement direction of the resonators 20.

In addition, the direction of the continuous change of the refractive index in the single period of the liquid crystal layer 16 may match with the y direction of the arrangement direction of the resonators 20. Alternatively, the direction of the continuous change of the refractive index in the single period of the liquid crystal layer 16 may be an oblique direction in FIG. 2 as an intermediate direction between the x direction and the y direction. Alternatively, the direction of the continuous change of the refractive index in the single period of the liquid crystal layer 16 may have no relationship with the y direction of the arrangement direction of the resonators 20.

That is, in the liquid crystal layer 16, the repeating direction of the single period may match with the y direction of the arrangement direction of the resonators 20. Alternatively, the direction of the continuous change of the refractive index in the liquid crystal layer 16 may be an oblique direction in FIG. 2 as an intermediate direction between the x direction and the y direction or may have no relationship with the arrangement of the resonators 20, and various configurations can be used.

Further, the direction of the continuous change of the refractive index in the single period of the liquid crystal layer 16, that is, the repeating direction of the single period may be both of the x direction and the y direction of the arrangement direction of the resonators 20.

The metasurface structure 12 typically has no period.

Therefore, in the optical member 10 according to the embodiment of the present invention, the reflection direction of incident electromagnetic waves matches with the direction of the continuous change of the refractive index, that is, the repeating direction of the single period in the liquid crystal layer 16. Accordingly, the reflection direction of incident electromagnetic waves can be appropriately adjusted by these selections.

In addition, around the resonators 20 positioned at the center of the optical member 10, the liquid crystal layer 16 may include the direction in which the refractive index continuously changes in the single period, that is, the repeating direction of the single period in a radial shape from the positions corresponding to the resonators at the center.

With the above-described configuration where the in-plane refractive index changes in the radial shape, an optical member that reflects electromagnetic waves to collect the electromagnetic waves to the center by changing the in-plane refractive index of the liquid crystal layer 16 such that the in-plane refractive index continuously decreases from the center toward the outer direction can be obtained. In addition, with the above-described configuration where the in-plane refractive index changes in the radial shape, an optical member that reflects electromagnetic waves to diffuse the electromagnetic waves in a radial shape from the center by changing the in-plane refractive index of the liquid crystal layer 16 such that the in-plane refractive index continuously increases from the center toward the outer direction can be obtained.

Further, by combining this configuration with the above-described configuration where the liquid crystal layer 16 includes the regions that are different in the number of the resonators 20 corresponding to the single period, the collection efficiency or the diffusion efficiency of reflected electromagnetic waves can be improved.

As can be seen from the above description, in the optical member according to the embodiment of the present invention, by appropriately selecting the direction of the change of the in-plane refractive index, the amount of change of the in-plane refractive index, the size of the in-plane refractive index, the length of the single period where the in-plane refractive index changes from the maximum value to the minimum value, the number of the resonators 20 corresponding to the single period, and the like in the liquid crystal layer 16, reflection characteristics of the optical member can be adjusted in various ways.

Accordingly, in the optical member according to the embodiment of the present invention, by appropriately selecting the liquid crystal layer 16 to be combined with one kind of the metasurface structure 12, various reflective optical members that are different in reflection characteristics of electromagnetic waves can be realized. Accordingly, in the optical member according to the embodiment of the present invention, by appropriately selecting the liquid crystal layer 16 to be combined with one kind of the metasurface structure 12, an optical member can be customized to have desired reflection characteristics of electromagnetic waves.

That is, in the optical member according to the embodiment of the present invention, both of the metasurface structure 12 and the liquid crystal layer 16 do not need to be designed together to obtain desired reflection characteristics, and can be handled as independent components.

Accordingly, the optical member according to the embodiment of the present invention is not limited to being customized by the change of the liquid crystal layer 16, and may be customized by fixing the liquid crystal layer 16 and selecting the metasurface structure 12.

However, the customization by the change of the liquid crystal layer 16 is advantageous in consideration of the degree of freedom of design, ease of design, simple manufacturing, and the like.

In addition, in the optical member according to the embodiment of the present invention, the metasurface structure is not limited to the configuration where one kind of resonators are arranged at regular intervals in the x direction and the y direction orthogonal to each other, and various configurations can be used.

For example, in the optical member according to the embodiment of the present invention, the metasurface structure may have a configuration in which plural kinds of resonators 20 may be used in combination. For example, in the metasurface structure, different kinds of resonators 20 may be used in the single period of the liquid crystal layer 16. Alternatively, in the metasurface structure, the resonators 20 to be used may vary depending on the single period. Alternatively, in the metasurface structure, different kinds of resonators 20 may be used depending on the number of the resonators 20 corresponding to the single period of the liquid crystal layer 16. In this case, in various kinds of resonators 20, the phase modulation amounts, that is, the refractive indices may be the same as or different from each other.

In addition, the arrangement interval of the resonators 20 is not limited to the regular interval, and may gradually increase or may gradually decrease in the x direction and/or the y direction. Alternatively, regarding the arrangement interval of the resonators 20, a region where the interval increases and a region where the interval decreases may be mixed. Alternatively, the arrangement intervals of the resonators 20 in the x direction and the y direction may be different.

Further, the arrangement direction of the resonators 20 is not limited to the two-dimensional arrangement in the x direction and the y direction orthogonal to each other. That is, as the arrangement of the resonators 20, various aspects such as one-dimensional direction, a radial shape, a concentric shape, or an irregular (random) shape can be used.

In the optical member 10 according to the embodiment of the present invention, the wavelength of the target electromagnetic waves is not limited, and electromagnetic waves having various wavelengths including visible light, infrared light, and radio waves can be targeted.

In particular, from the viewpoint of efficiently obtaining the effects of the present invention, electromagnetic waves having a wavelength of 10 μm to 1 cm are suitably targeted, for example, in order to improve the utilization efficiency of electromagnetic waves to increase the reflectivity.

In addition, the polarization state of the target electromagnetic waves of the optical member according to the embodiment of the present invention is not limited and may be unpolarized light, linearly polarized light, circularly polarized light, or elliptically polarized light.

Note that, in a case where linearly polarized light is incident, it is preferable that the direction in which the refractive index continuously changes and a vibration direction of incident electromagnetic waves match with each other. For example, in the optical member 10 shown in FIGS. 1 and 2, it is preferable that electromagnetic waves are incident such that the x direction and the vibration direction of the electromagnetic waves match with each other. That is, in the optical member 10 shown in FIGS. 1 and 2, in a case where linearly polarized light is incident, it is preferable that linearly polarized light in the x direction is incident.

Hereinabove, the optical member according to the embodiment of the present invention has been described above. However, the present invention is not limited to the above-described examples, and various improvements and modifications can be made within a range not departing from the scope of the present invention.

### EXAMPLES

Hereinafter, the characteristics of the present invention will be described in detail using examples. Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Example 1

### <Formation of Metasurface Structure>

A COP film was manufactured using a method described in JP4991170B. The thickness of the COP film was 40 μm.

After ultrasonically cleaning (45 kHz) the surface of the COP film, the COP film was placed on a film forming position in a sputtering film forming device. After reducing the internal pressure of the device, argon gas was introduced, and the target was sputtered with Cu to form a copper layer having a thickness of 200 μm on the surface of the COP film.

Next, a photosensitive transfer member (negative tone transfer material 1) described in JP2020-204757A was unwound, and one cover film was peeled off from the photosensitive transfer member.

Next, the photosensitive transfer member and the COP film where the copper layer was formed on both surfaces were bonded to each other such that the photosensitive resin layer exposed by the peeling of the cover film and the copper layer were in contact with each other. As a result, a laminate was obtained. This bonding step was performed under conditions of a roll temperature of 100° C., a linear pressure of 1.0 MPa, and a linear speed of 4.0 m/min.

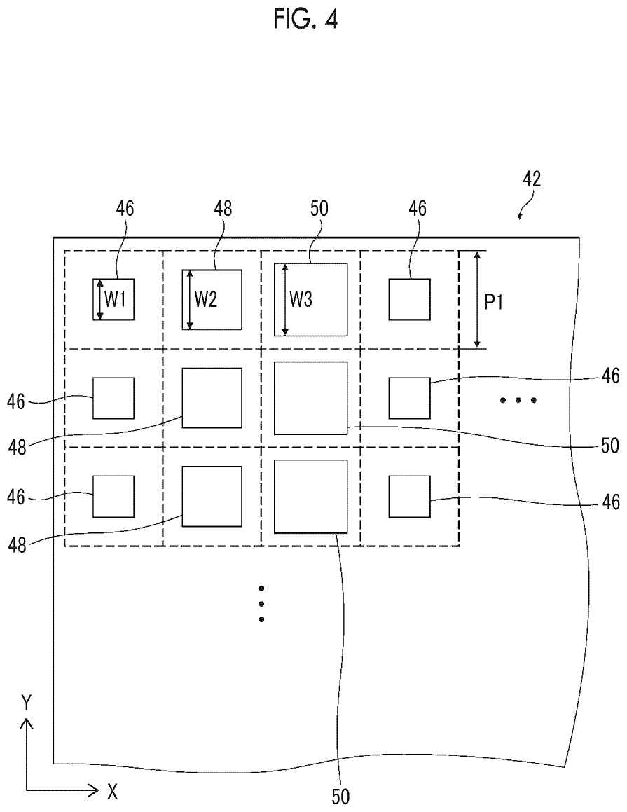

The obtained laminate was irradiated from the cover film of the photosensitive transfer member with light from a ultra-high pressure mercury lamp (exposure main wavelength: 365 nm) through a photo mask 42 shown in FIG. 4 at 100 mJ/cm² to expose the photosensitive resin layer.

In the photo mask 42 shown in FIG. 4, square sections having one side length of P1 (360 μm) were two-dimensionally set in a square grid shape in an X direction and an Y direction orthogonal to each other. The X direction and the Y direction correspond the X direction and the Y direction of a reflective metasurface diffraction grating (metasurface structure) described below.

At the center of each of the square sections, any one of a square opening 46 having one side length of W1 (100 μm), a square opening 48 having one side length of W2 (265 μm), or a square opening 50 having one side length of W3 (283 μm) was formed.

In the photo mask 42, the opening 46, the opening 48, and the opening 50 were repeatedly formed in this order in the X direction. In addition, the same kind of openings are arranged in the Y direction. That is, in the photo mask, repeating columns of the opening 46, the opening 48, the opening 50, the opening 46, the opening 48, the opening 50, the opening 46, the opening 48, and . . . are present in the X direction, and The columns in the X direction are arranged in the Y direction.

The photo mask was removed after exposing the photosensitive transfer member, and the cover film was peeled off from the photosensitive transfer member.

Next, shower development was performed for 30 seconds using 1.0 mass % of a sodium carbonate aqueous solution having a liquid temperature of 25° C. to form a resist pattern consisting of the photosensitive transfer member on the copper layer.

The laminate where the resist pattern was formed was etched with a copper etchant (Cu-02, manufactured by Kanto Chemical Co., Inc.) at 23° C. for 30 seconds.

Next, by peeling off the resist pattern using propylene glycol monomethyl ether acetate, a metasurface structure was formed.

### <Formation of Reflective Layer>

After ultrasonically cleaning (45 kHz) the surface of the COP film, the COP film was placed on a film forming position in a sputtering film forming device. After reducing the internal pressure of the device, argon gas was introduced, and the target was sputtered with Cu to form a copper layer having a thickness of 200 μm on the surface of the COP film. This copper layer was used as a reflective layer.

### <Formation of Alignment Film>

As a support, a COP film was prepared.

41.6 parts by mass of butoxyethanol, 41.6 parts by mass of dipropylene glycol monomethyl, and 15.8 parts by mass of pure water were added to 1 part by mass of a photo-alignment material E-1 having the following structure, and the obtained solution was filtered under pressure through a 0.45 μm membrane filter to prepare a coating liquid for forming a photo-alignment film.

Next, the obtained coating liquid for forming a photo-alignment film was applied to the support and was dried at 60° C. for 1 minute. Next, the obtained coating film was irradiated with linearly polarized ultraviolet light (illuminance: 4.5 mW/cm², cumulative irradiation dose: 300 mJ/cm²) using a polarized ultraviolet exposure device to manufacture a photo-alignment film P−1 having an alignment restriction force in the horizontal direction. The thickness of the photo-alignment film P−1 was 60 nm.

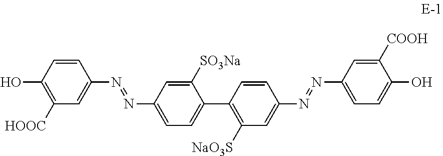

A stripe-shaped mask where a transmission portion having a width of 120 μm and a width of 960 μm were alternately formed was prepared. In this mask, the arrangement direction of the stripe corresponds to the X direction of the reflective metasurface diffraction grating (metasurface structure), and the arrangement direction of the stripe corresponds to the Y direction of the reflective metasurface diffraction grating.

The photo-alignment film P−1 was covered with the mask such that an end part of the transmission portion in the width direction matched with one edge side of the photo-alignment film P−1 and the transmission portion was positioned in a plane of the photo-alignment film P-1.

Next, using an ultraviolet exposure device, the photo-alignment film P−1 was irradiated with ultraviolet light that was linearly polarized by a wire grid polarizer (ProFlux PPL 02, manufactured by Moxtek, Inc.) provided such that an angle of an absorption axis was ϕ1 (=34°). In the ultraviolet light, the illuminance was 4.5 mW/cm², and the cumulative irradiation dose was 300 mJ/cm².

The angle of the absorption axis is the angle with respect to the width direction of the stripe and is positive clockwise. That is, the angle of the absorption axis being 0° represents a state where the angle of the absorption axis matches with the width direction (X direction) of the stripe. That is, the angle of the absorption axis being 90° represents a state where the angle of the absorption axis matches with the longitudinal direction (Y direction) of the stripe.

Next, after moving the mask in the width direction of the stripe by 120 μm and rotating the wire grid polarizer such that the angle of the absorption axis was ϕ2 (=84°), the photo-alignment film P−1 was irradiated with linearly polarized ultraviolet light using the same method as described above.

Next, after moving the mask in the width direction of the stripe by 120 μm and rotating the wire grid polarizer such that the angle of the absorption axis was 43 (=40°), the photo-alignment film P−1 was irradiated with linearly polarized ultraviolet light using the same method as described above.

The movement of the mask and the ultraviolet irradiation of the photo-alignment film P−1 were performed until the wire grid polarizer was rotated such that the angle of the absorption axis was changed to ϕ4, ϕ5, . . . , and ϕ9.

As a result, a photo-alignment film where a stripe-shaped alignment pattern having a width of 120 μm was formed and the angles ϕ1 to ϕ9 of the alignment direction were repeated was manufactured.

As the angles of the absorption axis of the wire grid polarizer,
ϕ1 was 34°, ϕ2 was 84°, ϕ3 was 40°,
ϕ4 was 5°, ϕ5 was 34°, ϕ6 was 59°,
ϕ7 was 58°, ϕ8 was 27°, and ϕ9 was 14°.

### <Liquid Crystal Composition>

As the liquid crystal composition forming the liquid crystal layer (phase correction layer), the following composition A-1 was prepared.

### Composition A-1

| | |
|---|---|
| Liquid crystal compound L-1 | 100.00 parts by mass |
| Polymerization initiator (IRGACURE-OXE01, manufactured by BASF SE) | 1.00 part by mass |
| Leveling agent T-1 | 0.08 parts by mass |
| Methyl ethyl ketone | 1050.00 parts by mass |

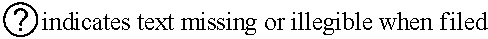

Liquid Crystal Compound L-1 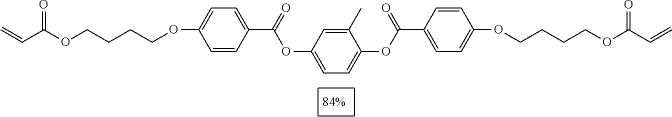 [SMILES: C=CC(=O)OCCCCOc1ccc(C(=O)Oc2ccc(OC(=O)c3ccc(OCCCCOC(=O)C=C)cc3)c(C)c2)cc1] 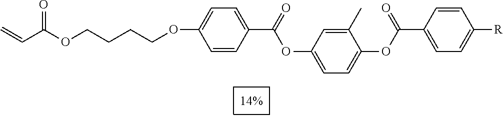 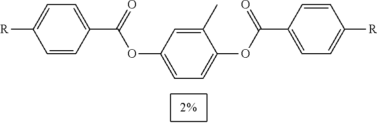 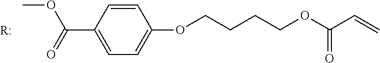
Leveling Agent T-1

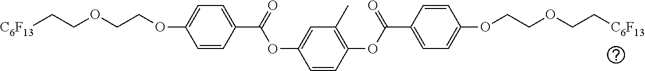

### <Formation of Liquid Crystal Alignment Pattern Layer>

Regarding the first liquid crystal layer, the following composition A-1 was applied to the photo-alignment film P−1 to form a coating film, the coating film was heated to 80° C. using a hot plate, the coating film was irradiated with ultraviolet light having a wavelength of 365 nm at an irradiation dose of 300 mJ/cm² using a high-pressure mercury lamp in a nitrogen atmosphere. As a result, the alignment of the liquid crystal compound was immobilized.

Regarding the second or subsequent liquid crystal immobilized layer, the composition was applied to the first liquid crystal layer, and the applied composition was heated and irradiated with ultraviolet light for curing under the same conditions as described above. As a result, a liquid crystal immobilized layer was manufactured. This way, by repeating the application multiple times until the total thickness reached a desired thickness, a liquid crystal alignment pattern layer was formed, and a liquid crystal layer for forming the phase correction layer was manufactured. In the liquid crystal layer, a region where the horizontally aligned liquid crystal compound was immobilized, a region where the vertically aligned liquid crystal compound was immobilized, and a region where the alignment direction of the liquid crystal compound was gradually changed and immobilized from the vertical alignment to the horizontal alignment between the two regions were present.

In the liquid crystal alignment pattern layer formed of the composition A-1, the refractive index during the horizontal alignment was 1.7, and the refractive index during the vertical alignment was 1.55, and a retardation was able to be given due to a difference between the refractive index during the horizontal alignment and the refractive index during the vertical alignment.

### <Manufacturing of Liquid Crystal Layer>

A liquid crystal alignment pattern layer having a thickness of 40 μm was formed on the photo-alignment film manufactured as described above using the above-described composition A-1 with the above-described method, and the liquid crystal alignment pattern layer was peeled off from the photo-alignment film to obtain a liquid crystal layer.

During the formation of the photo-alignment film, the angles of the absorption axis of the wire grid polarizer were as described above.

Accordingly, the formed liquid crystal layer (liquid crystal alignment pattern layer) had the liquid crystal alignment pattern having a stripe shape with a width of 120 μm where the angles of the optical axis of the liquid crystal compound in the stripe including ϕ1 of 34°, ϕ2 of 84°, ϕ3 of 40°, ϕ4 of 5°, ϕ5 of 34°, ϕ6 of 59°, ϕ7 of 58°, ϕ8 of 27°, and ϕ9 of 14° were repeated in the arrangement direction of the stripe.

In addition, it was verified using AxoScan (manufactured by Axometrics, Inc.) that the direction of the optical axis (slow axis) of the liquid crystal compound in the stripe had the above-described angles.

### <Manufacturing of Optical Member>

Using an acrylic pressure sensitive adhesive, the metasurface structure was transferred and bonded to one surface of the liquid crystal layer manufactured as described, and the reflective layer was transferred and bonded to another surface of the liquid crystal layer. As a result, an optical member shown in FIG. 1 was manufactured.

The liquid crystal layer was laminated such that the width direction of the stripe in the liquid crystal alignment pattern matched with the X direction in the metasurface structure and the longitudinal direction of the stripe matched with the Y direction in the metasurface structure.

As described above, in the metasurface structure, the square section having one side length of 360 μm in one resonator was a unit cell. In addition, in the metasurface structure, a resonator having a square shape with one side length of W1 (100 μm), a resonator having a square shape with one side length of W2 (265 μm), and a resonator having a square shape with one side length of W3 (283 μm) were repeatedly arranged in this order in the X direction. On the other hand, the same kind of resonators were arranged in the Y direction.

Further, the width W4 of the stripe in the liquid crystal alignment pattern was 120 μm.

Accordingly, the optical member had a structure in which, as conceptually shown in FIG. 5,
regions where the angles of the optical axis of the liquid crystal compound in the liquid crystal layer were ϕ1, ϕ2, and ϕ3 were positioned in the unit cell of the resonator having one side length of W1,
regions where the angles of the optical axis of the liquid crystal compound in the liquid crystal layer were ϕ4, ϕ5, and ϕ6 were positioned in the unit cell of the resonator having one side length of W2,
regions where the angles of the optical axis of the liquid crystal compound in the liquid crystal layer were ϕ7, ϕ8, and ϕ9 were positioned in the unit cell of the resonator having one side length of W3, and
the in-plane refractive index of the liquid crystal layer continuously changed according to the region where two or more microstructures arranged adjacent to each other were present.

In FIG. 5, the reflective layer was shown below the liquid crystal layer in the drawing.

As described above, in the optical member shown in FIG. 5, in the square resonators configuring the metasurface structure, the one side length W1 was 100 μm, the one side length W2 was 265 μm, the one side length W3 was 283 μm, and the thickness T1 was 200 nm. In addition, the length P1 of the square section as one unit cell was 360 μm. Accordingly, a total length P2 of the three unit cells that were repeatedly formed was 1080 μm.

Further, the liquid crystal layer includes a liquid crystal alignment pattern layer having a striped liquid crystal alignment pattern having a thickness T2 of 40 μm that extends in the Y direction and is arranged in the X direction, and a width W4 of the stripe is 120 μm.

### Comparative Example 1

An optical member was manufactured using the same method as that of Example 1, except that the liquid crystal layer according to Example 1 was changed to the following isotropic dielectric layer. The isotropic dielectric layer was manufactured as follows.

A block polyamic acid imide varnish A described in [0130] of JP2017-175201A was applied to a support glass by spin coating (500 rpm, 5 s, 1500 rpm, 60 s) to form a polyimide precursor film.

Next, the polyimide precursor film was cured by a heat treatment (260° C., 2 h) to form a polyimide film. By repeating this application 10 times, a polyimide film having a thickness of 40 μm was manufactured.

The polyimide film was peeled off to obtain the isotropic dielectric layer. The thickness was 40 μm.

### [Evaluation]

Using the following method, the reflection efficiency of the manufactured optical member (reflective diffraction grating) was measured.

In a case where light was incident (the polarization direction was the y-axis direction) in to the manufactured optical member using Impatt Diode having a central wavelength of 300 GHz as a light source and was reflected, the diffraction reflection to a designed angle (67°) was imaged using a two-dimensional Sub-Thz imaging camera (Tera-1024, manufactured by Terasense Group Inc.).

The integrated value of luminance of all the pixels of the imaging camera was obtained as the reflection intensity in this direction.

The reflection intensities in directions of negative first-order (−67°), zero-order (specular reflection, 0°), and positive first-order (67°) were measured as P−1, P0, and P1. A ratio (P1/(P−1+P0+P1)) of reflection in the designed direction (positive first-order, 67°) was defined as the reflection efficiency.

As a result,
the reflection efficiency of Example 1 was 80%, and
the reflection efficiency of Comparative Example 1 was 72%.

The above results show that, in the optical member according to the embodiment of the present invention, the reflectivity of electromagnetic waves in a desired direction is high, that is, the utilization efficiency of light is high.

As can be seen from the above results, the effects of the present invention are obvious.

The present invention can be suitably used for a reflective plate of electromagnetic waves including visible light, a beam steering device, or the like.

### EXPLANATION OF REFERENCES

10: optical member
12, 100: metasurface structure
14: reflective layer
16, 104: liquid crystal layer
18: substrate
20, 100a: resonator
24, 104a: liquid crystal compound
42: photo mask
46, 48, 50: opening
102: electrode layer

What is claimed is:

1. An optical member comprising, in the following order:
a reflective layer;
a liquid crystal layer that includes a liquid crystal compound; and
a metasurface structure where a plurality of microstructures are arranged,
wherein an in-plane refractive index of the liquid crystal layer continuously changes according to a region of the metasurface structure where two or more microstructures arranged adjacent to each other are present.

2. The optical member according to claim 1,
wherein all of the plurality of microstructures have the same structure.

3. The optical member according to claim 1,
wherein the plurality of microstructures are arranged at regular intervals.

4. The optical member according to claim 1,
wherein in the liquid crystal layer, the liquid crystal compound is immobilized.

5. The optical member according to claim 1,
wherein in the liquid crystal layer, an angle between an optical axis of the liquid crystal compound and a main surface of the liquid crystal layer continuously changes.

6. The optical member according to claim 1,
wherein a direction in which the in-plane refractive index continuously changes in the liquid crystal layer and
an arrangement direction of the microstructures in the metasurface structure match with each other.

7. The optical member according to claim 1,
wherein in a case where a region of the liquid crystal layer where the in-plane refractive index changes from a maximum value to a minimum value is set as a single period,
the liquid crystal layer repeatedly includes the single period in at least one direction.

8. The optical member according to claim 1,
wherein a wavelength of target electromagnetic waves is 10 μm to 1 cm.

9. The optical member according to claim 2,
wherein the plurality of microstructures are arranged at regular intervals.

10. The optical member according to claim 2,
wherein in the liquid crystal layer, the liquid crystal compound is immobilized.

11. The optical member according to claim 2,
wherein in the liquid crystal layer, an angle between an optical axis of the liquid crystal compound and a main surface of the liquid crystal layer continuously changes.

12. The optical member according to claim 2,
wherein a direction in which the in-plane refractive index continuously changes in the liquid crystal layer and
an arrangement direction of the microstructures in the metasurface structure match with each other.

13. The optical member according to claim 2,
wherein in a case where a region of the liquid crystal layer where the in-plane refractive index changes from a maximum value to a minimum value is set as a single period,
the liquid crystal layer repeatedly includes the single period in at least one direction.

14. The optical member according to claim 2,
wherein a wavelength of target electromagnetic waves is 10 μm to 1 cm.

15. The optical member according to claim 3,
wherein in the liquid crystal layer, the liquid crystal compound is immobilized.

16. The optical member according to claim 3,
wherein in the liquid crystal layer, an angle between an optical axis of the liquid crystal compound and a main surface of the liquid crystal layer continuously changes.

17. The optical member according to claim 3,
wherein a direction in which the in-plane refractive index continuously changes in the liquid crystal layer and
an arrangement direction of the microstructures in the metasurface structure match with each other.

18. The optical member according to claim 3,
wherein in a case where a region of the liquid crystal layer where the in-plane refractive index changes from a maximum value to a minimum value is set as a single period,
the liquid crystal layer repeatedly includes the single period in at least one direction.

19. The optical member according to claim 3,
wherein a wavelength of target electromagnetic waves is 10 μm to 1 cm.

20. The optical member according to claim 4,
wherein in the liquid crystal layer, an angle between an optical axis of the liquid crystal compound and a main surface of the liquid crystal layer continuously changes.
